(19) United States
(12) Patent Application Publication
(10) Pub. No.: US 2011/0321125 A1
(43) Pub. Date: Dec. 29, 2011

(54) AUTHENTICATION DEVICE, AUTHENTICATION METHOD AND PROGRAM FOR CAUSING COMPUTER TO EXECUTE THE SAME

(76) Inventors: Satoshi Kyohgoku, Osaka (JP); Katsuhiko Umetsu, Osaka (JP)

(21) Appl. No.: 13/148,511

(22) PCT Filed: Feb. 8, 2010
(86) PCT No.: PCT/JP2010/051776

§ 371 Date: Aug. 9, 2011

(30) Foreign Application Priority Data
Feb. 10, 2009 (JP) 2009-028513

(51) Int. Cl. H04L 9/32

(52) U.S. Cl. 726/2

(57) ABSTRACT

Provided is an authentication device and an authentication method of, even in the case of selecting correct images for authentication from among the displayed images to perform authentication, making hard to be read by others and improving security, and a program for causing a computer to execute the same. A main control portion 12 selects at random one or more correct images 23 to be displayed from a correct image DB 17 within the number of images to be displayable by a display portion 14 so as to be stored in a display correct image storage portion 19. Dummy images are selected only by the number of images that are displayable by the display portion 14 from a dummy image DB 18. The main control portion 12 lists and displays the selected display images on the display portion 14. The main control portion 12 changes a display number and display arrangement of correct images and dummy images so as to be differentiated from those in previous authentication. When a user selects correct images, an authentication control portion 13 compares correct images 23 that are registered in the display correct image storage portion 19 to images that are selected by the user, and in the case of coincidence, authentication is completed.

### TECHNICAL FIELD

The present invention relates to an authentication device and an authentication method for selecting a correct image from among displayed images to perform authentication, and a program for causing a computer to execute the same.

### BACKGROUND ART

Conventionally, a password has been used for authentication to complete authentication in a case where numerals, alphabets and the like are sequentially input by key operation, which are coincident with the password that is registered in advance. However, a problem is caused such that a simple password increases the possibility that the password is read by others, and conversely, a complicated password makes operation complicated as well as causes to hardly memorize the password itself.

Therefore, Paten Literature 1 describes that a plurality of keys are simultaneously input. This makes it possible to quickly complete key operation in order to complete authentication by one time key inputting, and makes it difficult to be read by others which keys are input in order.

### PRIOR ART LITERATURE

### Patent Literature

Patent Literature 1: Japanese Patent Application Laid-open No. 2008-152757

### SUMMARY OF INVENTION

### Problems to be Solved by the Invention

However, in limited space such as a portable phone, even space for arranging input keys is narrow so that the number of keys is also limited. Accordingly, even though correct authentication keys are not recognized, all patterns of key inputting are investigated, whereby it is possible to find the authentication keys that are simultaneously pressed.

FIG. 6 is an illustrative view for authentication image display of a conventional portable phone, and (a) shows correct images for authentication and (b) shows images that are displayed on the portable phone. Such a portable phone 101 has the limited number of images that are displayable on a display portion 102, and 9 images are displayable in the view. Among them, it is assumed that there are 0.3 correct images 100 for authentication (see FIG. 6(a)). There are

₉C₃=84 patterns

of a combination for selecting 3 correct images from among 9 images. Therefore, in a case where it is found that there are 3 images selected by a user, it is possible to reach correct images for the third party by presses the 84 patters.

In view of the foregoing circumstances, the present invention intends to provide an authentication device and an authentication method of, even in the case of selecting correct images for authentication from among the displayed images to perform authentication, making hard to be read by others and improving security, and a program for causing a computer to execute the same.

### Means for Solving the Problems

The present invention provides an authentication device for performing authentication by being made to select a correct item group having one or more predetermined items from displayed item groups, including

a storage portion for storing the correct item group; a display portion for displaying the item groups; an input operation portion for selecting from the item groups; and a control portion for selecting the correct item group comprising a different number of items from that in previous authentication from the storage portion to be listed and displayed on the display portion, and determining that authentication is succeeded in a case where all in the correct item group are selected by the input operation portion.

Here, “in previous authentication” means “prior to the present authentication”.

Here, the control portion may change a display position of the correct item group from that in the previous authentication, may change a total number in the displayed item groups from that in the previous authentication, may determine that authentication is succeeded in a case where items constituting the correct item group are simultaneously selected, and may determine that authentication is succeeded in a case where items constituting the correct item group are selected in a predetermined order.

Further, the present invention provides an authentication method of performing authentication by being made to select a correct item group having one or more predetermined items from displayed item groups, including

a storage step of storing the correct item group in a storage portion; a display step of displaying the item groups on a display portion; an input operation step of selecting from the displayed correct item group by an input operation portion; and a control step of selecting the correct item group comprising the different number of items from that in previous authentication from the storage portion to be listed and displayed on the display portion, and determining that authentication is succeeded in a case where all in the correct item group are selected by the input operation portion.

Further, the present invention may be a program for causing a computer to execute the respective steps.

### Advantages of the Invention

According to the present invention, the number of displayed correct images is different from that in the previous authentication, thus having a low possibility to be authenticated by irresponsible input by the third party.

Additionally, a correct image and a dummy image that are displayed by a control portion are selected and displayed according to the number of the displayed correct images and each authentication, which are selected by a user, so that the displayed images are changed in each authentication processing to lower a possibility to be able to be authenticated by irresponsible selection, while the same correct image is not necessarily displayed next time even when a correct image is peeked and known by the third party during authentication processing, so that a possibility to be improperly authenticated becomes lowered to improve security.

Moreover, when the number of displayed correct images and display positions thereof are changed in each authentication processing, a possibility that the correct image is completely leaked is lowered and it becomes difficult to perform improper authentication again, so that security is improved. Additionally, assuming that the correct images are authenticated by simultaneously inputting, it becomes further difficult to recognize the positions and the images even when the correct images are peeked.

### BRIEF DESCRIPTION OF DRAWINGS

FIG. 1 is a block diagram showing an embodiment of an authentication device according to the present invention.

FIG. 2 is an illustrative view in which image display is performed by a portable phone as the authentication device.

FIG. 3 is a view showing an example of images that are stored in a storage portion.

FIG. 4 is a flowchart showing processing procedure for registering an authenticated correct image by the authentication device.

FIG. 5 is a flowchart showing processing procedure for performing authentication by the authentication device.

FIG. 6 is an illustrative view of authentication image display by a conventional portable phone.

### MODES FOR CARRYING OUT THE INVENTION

Hereinafter, description will be given for embodiments of the present invention with reference to the accompanying drawings.

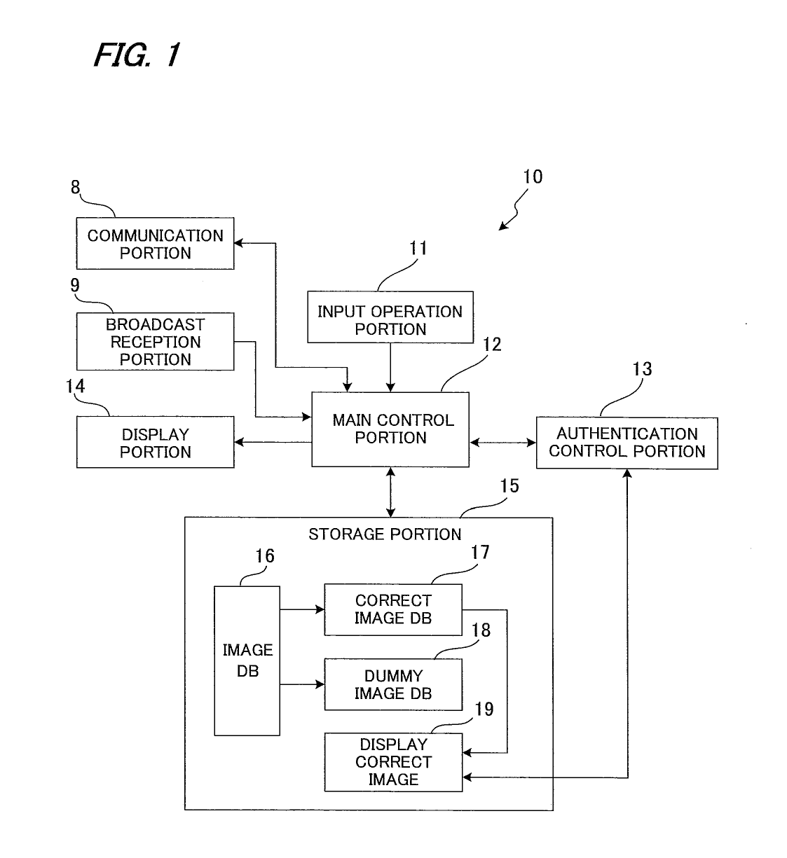

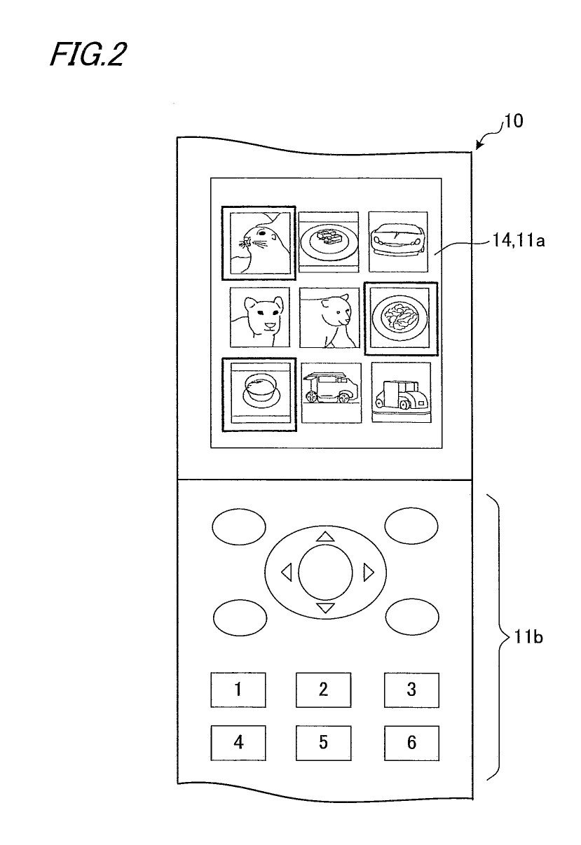

FIG. 1 is a block diagram showing an embodiment of an authentication device according to the present invention. FIG. 2 is an illustrative view in which image display is performed by a portable phone as the authentication device. In this embodiment, a portable phone serves as the authentication device, however, without limitation thereto, an information terminal such as a personal computer or a PDA is also usable.

Such an authentication device (portable phone) 10 has a communication portion 8, a broadcast reception portion 9, an input operation portion 11, a main control portion 12, an authentication control portion 13, a display portion 14 and a storage portion 15.

The communication portion 8 includes a phone call function and a mail function, and an access function to a network such as Internet, as a portable phone. The broadcast reception portion 9 includes a broadcast reception function for television broadcast, radio broadcast and the like.

Further, the display portion 14 is comprised of a panel made of liquid crystal, organic EL or the like, and provided with a touch panel capable of touch input on the surface thereof. Therefore, as shown in FIG. 2, the display portion 14 itself is an input operation portion 11a. Additionally, an input operation portion 11b is a part for performing input operation by operation keys. The input operation portion 11b is comprised of character keys indicating numerals and alphabets, and movement keys capable of making a cursor move horizontally and vertically. The input operation portions 11a and 11b may be configured to be able to have single-touch input in which respective portions simultaneously accept only one input, or configured to be able to have multi-touch input in which two or more inputs are simultaneously accepted.

The main control portion 12 performs control of each portion, and the authentication control portion 13 performs control in authentication.

The storage portion 15 is comprised of an image DB (database) 16 in which all images used in authentication processing are stored; a correct image DB 17 that stores correct images which are authenticated as correct; a dummy image DB 18 that stores dummy images which are authenticated as dummy; and a display correct image storage portion 19 that stores display correct images selected by the main control portion 12 from the images in the correct image DB 17.

Note that, all images used for authentication processing may be kept in the image DB 16, but not limited thereto. For example, images that are regarded as dummy may be present in another housing or the like other than the dummy image DB 18, or it is also considered that all of dummy images and correct images are stored in another server, and are obtained from another server in real time by utilizing the communication function of the communication portion 8 as needed. Further, as the dummy images, ones from stored certain images in advance may be used, and additionally, images of a broadcast program during receiving or that have been received in past times by utilizing the broadcast reception function of the broadcast reception portion 9 and images of a website may be used.

Further, in FIG. 2, images as authentication subjects are still images, but not limited thereto. For example, a moving image may be allowed, characters, numerals and symbols may be allowed, or a combination thereof may be allowed. Namely, a plurality of items (images) as the authentication subjects are displayed on the display portion 14, and in these item groups, correct items that are authenticated as correct and dummy items that are authenticated as dummy (incorrect) are mixed. Then, a user selects only correct items from thereamong, whereby authentication is succeeded.

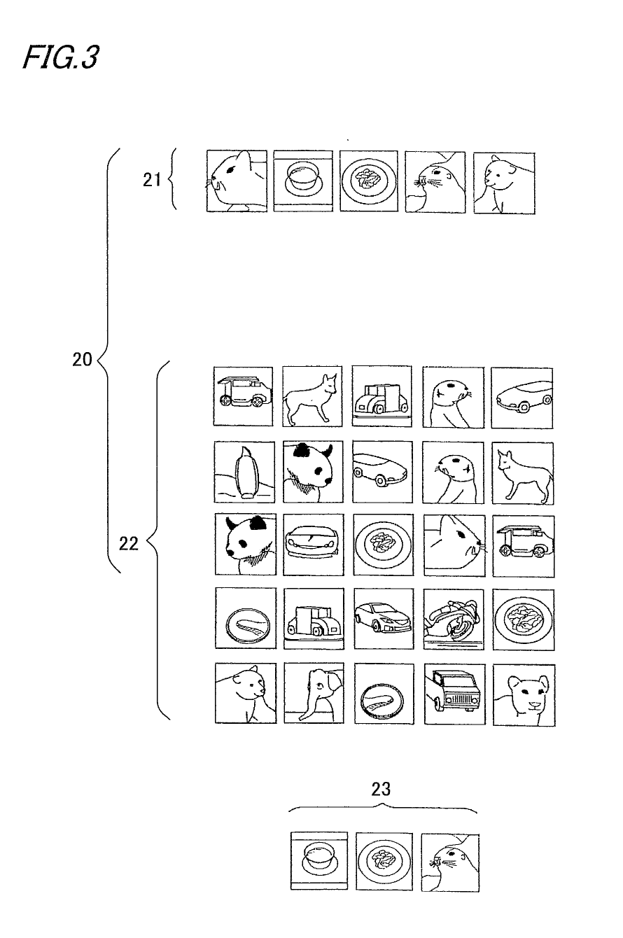

FIG. 3 shows images that are stored in each DB. In the image DB 16, all images 20 including correct images 21 and dummy images 22 of FIG. 3 are stored. A user performs registration processing of correct images in advance, and the correct images 21 registered by the user are stored in the correct image DB 17. In the dummy image DB 18, the dummy images 22 except the correct images 21 that are stored in the image DB 16 are stored. In the display correct image storage portion 19, display correct images 23 that are selected to be displayed on the display portion 14 from among the correct images 21 that are stored in the correct image DB 17 are stored.

At the display portion 14, as shown in FIG. 2, images of 3×3=9 are displayable, and correct images that are registered in advance for authentication are incorporated therein. In FIG. 2, the correct images are circled by a thick frame. A user simultaneously touches and selects correct images from among displayed images via the input operation portion 11a, or selects correct images by the input operation portion 11b. The authentication control portion 13 performs authentication judgment based on the images selected by the user.

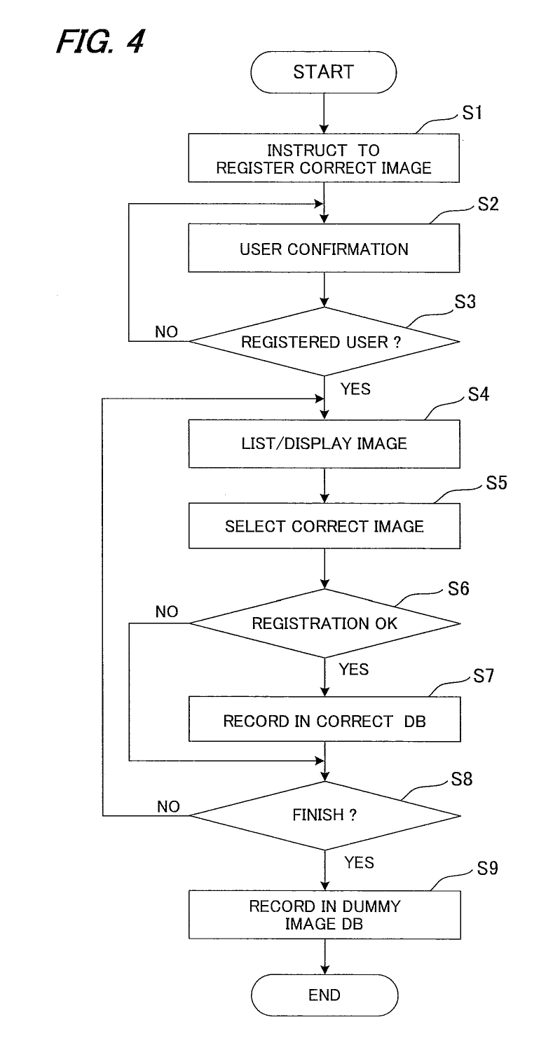

Next, description will be given for processing for registering correct images. FIG. 4 is a flowchart showing processing procedure for registering an authentication correct image by the authentication device.

A user inputs instructions for registering authentication correct images by using the input operation portion 11 (step S1). The authentication device 10 performs user confirmation (step S2). For example, display such as “Please input keys of your personal identification number.” is performed to cause a user to input keys. The main control portion 12 confirms with the input personal identification number whether the user is a registered user (step S3). In the case of the registered user (step S3; Yes), the process goes to step S4, and in the case of not the registered user (step S3; No), the process returns to step S2 to perform reconfirmation of the user.

Next, at step S4, the main control portion 12 makes a list of the images 20 from the image DB 16 to display the list on the display portion 14. At the time, it is possible only to display images of 3×3=9, thus displaying images after the tenth image by forwarding pages.

The user selects correct images for authentication from among the displayed images. The main control portion 12, when receiving information of selected images from the input operation portion 11 (step S5), circles the images by a thick frame, and performs display for confirming the user whether or not to be registered (step S6). For example, display is made such that “Please press “1” if registration is OK or “2” if registration is no good.”. In the case of permitting registration (step S6; Yes), the registered images are recorded in the correct image DB 17 (step S7). In the case of not permitting registration (step S6; No), the process goes to step S8. At step S8, confirmation is made for the user whether registration processing is finished. In a case where the registration processing is finished (step S8; Yes), the main control portion 12 records images other than correct images in the image DB 16 as the dummy images 22 in the dummy image DB 18 (step S9). In a case where the registration processing is not finished (step S8; No), the process returns to step S4 to continue the registration processing.

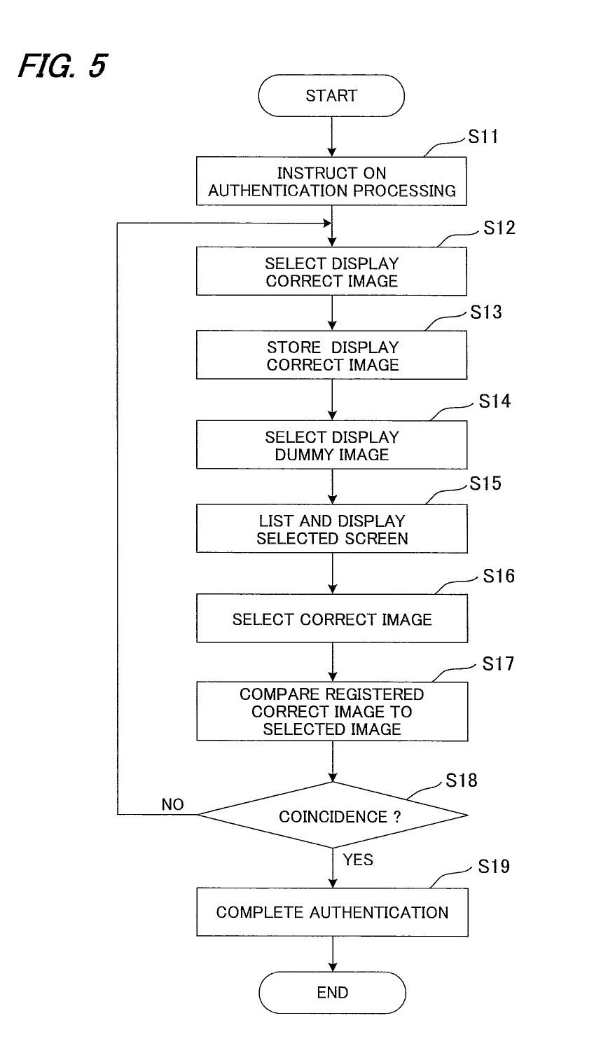

Next, description will be given for authentication processing. FIG. 5 is a flowchart showing processing procedure for performing authentication by the authentication device.

A user gives instructions on authentication processing from the input operation portion 11 (step S11). The main control portion 12 selects at random one or more correct images 23 to be displayed from the correct image DB 17 within the number of images to be displayable by the display portion 14 (step S12) so as to be stored in the display correct image storage portion 19 (step S13). The main control portion 12 then selects dummy images only by the number of images that are displayable by the display portion 14 from the dummy image DB 18 (step S14). For example, in the case of 3 correct images, the number of images to be displayable is 9, thus selecting 6 dummy images. The main control portion 12, as shown in FIG. 2, lists and displays the selected display images on the display portion 14 (step S15).

The main control portion 12 may change a display number and display arrangement of correct images and dummy images in each authentication processing, or may differentiate the display number and the display arrangement of correct images and dummy images from any of those in prior authentication (in previous authentication). In a case where the display number and the display arrangement of correct images and dummy images are changed in each authentication, the main control portion 12 differentiates the display number and the display arrangement of correct images and dummy images, since which are stored in the storage portion 15 in each authentication, from those in last authentication.

Examples of changing the display number described above includes the ways of changing that (1) the number of correct images is increased or decreased compared to the previous one, and (2) the number of dummy images is increased or decreased compared to the previous one. (1) and (2) may be used in combination, or one of them may be used (example of using only one of them: the number of correct images is increased and the number of dummy images is not changed). Additionally, respective cases of (1) and (2) may include cases where (3) the total display number of correct images and dummy images is changed, and (4) the total display number of correct images and dummy images is not changed.

It is also considered that examples of changing the display arrangement include not only a case where an absolute position and a display coordinate of a correct image and/or a dummy image on the display portion 14 are changed (Example: a position of a correct image is changed from a coordinate (1, 1) to a coordinate (1, 3)), but also a case where relative positions of a plurality of images are changed (Example: Display such that a correct image is arranged on an upper side and a dummy image is arranged on a lower side is changed to display so that a correct image is arranged on a lower side and a dummy image is arranged on an upper side. Alternatively, arrangement is changed to such that a correct image is on the left and a dummy image is on the right), and the like. Moreover, it is also considered that positions of a correct image and/or a dummy image are not changed, but a type of an image that is displayed is changed (Example: A correct image is changed from A to B. A dummy image is changed from C to D.).

In a case where the display number and the display arrangement of correct images and dummy images are changed from those in prior authentication, the storage portion 15 stores the display number and the display arrangement of correct images and dummy images in a predetermined number of authentications, and the main control portion 12 configures such that any of them are differentiated from the others. Accordingly, since it may be also considered to become the same display number or the same display position as those in previous authentication, it is not always true that the display number and the display arrangement of correct images and dummy images are changed in each authentication.

A user selects correct images from images that are displayed on the display portion 14 through the input operation portion 11, and information of the selected images is transmitted from the input operation portion 11 to the main control portion 12 (step S16). Correct images may be selected by simultaneously touching and inputting on the display portion 14 with the fingers, or may be selected one by one in order by key operation. The main control portion 12 sends the selected correct image data to the authentication control portion 13, and the authentication control portion 13 compares the correct images 23 that are registered in the display correct image storage portion 19 to images that are selected by the user (step S17). When the registered correct images are coincident with the selected images (step S18; Yes), the authentication control portion 13 determines that authentications is succeeded so that authentication is completed, and authentication processing is finished (step S19). When the registered correct images are not coincident with the selected images (step S18; No), the process returns to step S12 to continue authentication processing.

Here, a trigger for performing comparison of images by the authentication device (step S17) after a user selects images (step S16) may be when the passage of time is detected such as time from the start of authentication processing, or time after images are selected, or when another key provided different from keys for selecting a correct image and a dummy image is touched. Further, a judgment method is also considered such that determination is made that authentication is failed immediately when ones other than correct images are selected and a main control portion displays on the display portion 14 a message indicating that authentication is failed, an the like.

The main control portion 12 adds a change so that the display number of correct images is differentiated from that displayed at any point of prior authentication processing, and additionally, display positions of correct images and dummy images are also changed. As shown in FIG. 2, it is assumed that there are 9 display images, and combinations of selecting correct images that are present therein are as follows.

TABLE 1

| Selection number of | Number of combinations of |
|---|---|
| correct images | selection |
| 1, 8 | ₉C₁ = ₉C₈ = 9 patterns |
| 2, 7 | ₉C₂ = ₉C₇ = 36 patterns |
| 3, 6 | ₉C₃ = ₉C₆ = 84 patterns |
| 4, 5 | ₉C₄ = ₉C₅ = 126 patterns |
| 9 | ₉C₉ = 1 pattern |
| Total | 511 patterns |

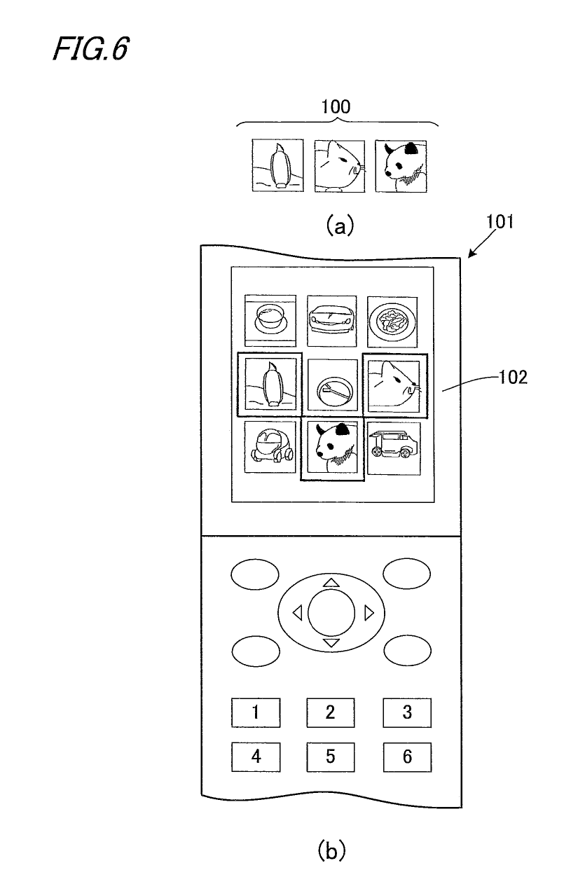

In this manner, the number of combinations is extraordinarily increased compared to a conventional example of FIG. 6, and it is difficult to find out correct images by which the third party inputs total combinations. Further, the main control portion 12 changes correct images and dummy images to be displayed and the number and the display positions thereof are also changed, thus having a low possibility to display the same images next time even when the third party peeps to recognize correct images. Therefore, a possibility to be improperly authenticated is lowered, and security is significantly improved. When correct images are selected and authenticated from among a plurality of displayed images in this manner, it is possible to secure sufficient security even in the case of a device having small display space such as a portable phone.

Note that, in the above-described embodiment, it is described that an order of selecting correct images is not considered, however, the order of selecting correct images may be registered in the storage portion 15 in advance. In this case, when the main control portion 12 selects correct images, a user selects images in order according to the order of selection. When images are not selected by the main control portion 12 in the middle of the order of selection, the user performs selection in order by skipping the images that are not selected. The authentication device determines, when the order of selection complies with the registered order of selection, that authentication is succeeded.

Note that, in the above-described embodiment, correct images are described by differentiating from dummy images, however, a case where these images are not differentiated from one another is also considered.

For example, assuming that numerals of 0 to 9 are registered as images, the same effect is obtained even when correct numerals and correct number of digits come to be different values. In a sequence of authentication procedure, there is, as an example, a case where a certain image is regarded as a correct image when selecting from certain display, and regarded as a dummy image when selecting from other display.

As this example, description will be given for a case where there are a correct set comprising “0” and “1” and a correct set comprising “4” and “6” as correct sets, and determination is made that authentication is succeeded when both sets are selected in a sequence of processing.

First, a case where “0”, “1”, “2” and “4” are displayed on the display portion 14 is regarded as correct when two images of “0” and “1” are selected. A case where “0”, “2”, “4”, “6” and “8” are displayed thereafter is regarded as correct when three images of “2”, “4” and “6” are selected (it is impossible to select a set of “0” and “1” because “1” is not displayed”). Then, determination is made that authentication is succeeded when correct sets are selected for both display.

Here, it is found that “0” is regarded as a correct image in the case of the former, and as a dummy image in the case of the latter, so that an image of “0” itself is not differentiated between a correct image and a dummy image.

Further, it is possible to realize by a computer the processing procedure of the authentication device according to the above-described embodiment. In such a case, a program in which processing contents of such functions are described is provided, which program is executed on a computer, whereby the above-described functions are realized on the computer. The program in which the processing contents are described may be provided by being recorded on a computer-readable recording medium, or provided via a network from a server, for example. The computer-readable recording medium includes a magnetic recording device, an optical disk, an optical magnetic recording medium, a semiconductor memory, and the like.

### DESCRIPTION OF REFERENCE NUMERALS

10 authentication device
11, 11a, 11b input operation portion
12 main control portion
13 authentication control portion
14 display portion storage portion
16 image DB
17 correct image DB
18 dummy image DB
19 display correct image storage portion images
21 correct images
22 dummy images
23 display correct images

1-8. (canceled)

9. An authentication device for performing authentication by being made to select a correct item group having one or more predetermined items from displayed item groups, comprising:
a storage portion for storing the correct item group;
a display portion for displaying the item groups;
an input operation portion for selecting from the item groups; and
a control portion for selecting the correct item group from the storage portion to be listed and displayed on the display portion, and determining that authentication is succeeded in a case where all in the correct item group are selected by the input operation portion, wherein
the control portion is able to select the number of items constituting the correct item group.

10. The authentication device according to claim 9, wherein the control portion changes a display position of the correct item group from that in the previous authentication.

11. The authentication device according to claim 9, wherein the control portion changes a total number in the displayed item groups from that in the previous authentication.

12. The authentication device according to claim 9, wherein the control portion determines that authentication is succeeded in a case where items constituting the correct item group are simultaneously selected.

13. The authentication device according to claim 9, wherein the control portion determines that authentication is succeeded in a case where items constituting the correct item group are selected in a predetermined order.

14. The authentication device according to claim 9, wherein the control portion is able to make any selections of which the number of correct items is increased or decreased compared to that in the previous authentication, or made the same as the number in the previous authentication, when the correct item group is listed and displayed on the display portion.

15. An authentication method of performing authentication by being made to select a correct item group having one or more predetermined items from displayed item groups, comprising:
a storage step of storing the correct item group in a storage portion;
a display step of displaying the item groups on a display portion;
an input operation step of selecting from the displayed correct item groups by an input operation portion; and
a control step of selecting the correct item group from the storage portion to be listed and displayed on the display portion, and determining that authentication is succeeded in a case where all in the correct item group are selected by the input operation portion, wherein
at the control step, the number of items constituting the correct item group is able to be selected.

16. A program for causing a computer to execute respective steps of the authentication method according to claim 15.

17. The authentication device according to claim 10, wherein the control portion changes a total number in the displayed item groups from that in the previous authentication.

18. The authentication device according to claim 10, wherein the control portion determines that authentication is succeeded in a case where items constituting the correct item group are simultaneously selected.

19. The authentication device according to claim 11, wherein the control portion determines that authentication is succeeded in a case where items constituting the correct item group are simultaneously selected.

20. The authentication device according to claim 10, wherein the control portion determines that authentication is succeeded in a case where items constituting the correct item group are selected in a predetermined order.

21. The authentication device according to claim 11, wherein the control portion determines that authentication is succeeded in a case where items constituting the correct item group are selected in a predetermined order.

22. The authentication device according to claim 10, wherein the control portion is able to make any selections of which the number of correct items is increased or decreased compared to that in the previous authentication, or made the same as the number in the previous authentication, when the correct item group is listed and displayed on the display portion.

23. The authentication device according to claim 11, wherein the control portion is able to make any selections of which the number of correct items is increased or decreased compared to that in the previous authentication, or made the same as the number in the previous authentication, when the correct item group is listed and displayed on the display portion.
